(19) United States
(12) Patent Application Publication
(10) Pub. No.: US 2024/0143341 A1
(43) Pub. Date: May 2, 2024

(54) APPARATUS, NON-TRANSITORY MACHINE-READABLE STORAGE MEDIUM, AND METHOD

(71) Applicants: Rajesh POORNACHANDRAN, PORTLAND, OR (US); Vincent J. ZIMMER, Issaquah, WA (US); Rajkumar KATTUR CHINNUSAMY, Bangalore (IN); Mallikarjuna CHILAKALA, Tigard, OR (US); Sreekanth YALACHIGERE, Portland, OR (US); Markus FLIERL, Portola Valley, CA (US); Brendan GREGG, Yowie Bay (AU)

(72) Inventors: Rajesh POORNACHANDRAN, PORTLAND, OR (US); Vincent J. ZIMMER, Issaquah, WA (US); Rajkumar KATTUR CHINNUSAMY, Bangalore (IN); Mallikarjuna CHILAKALA, Tigard, OR (US); Sreekanth YALACHIGERE, Portland, OR (US); Markus FLIERL, Portola Valley, CA (US); Brendan GREGG, Yowie Bay (AU)

(21) Appl. No.: 18/393,790

(22) Filed: Dec. 22, 2023

(51) Int. Cl. G06F 9/445

(52) U.S. Cl. CPC G06F 9/44505

(57) ABSTRACT

It is provided an apparatus comprising interface circuitry, machine-readable instructions, and processing circuitry to execute the machine-readable instructions. The machine-readable instructions comprise instructions to determine one or more configurable firmware variables of a computing system based on performance analysis data of the computing system executing a workload. The machine-readable instructions further comprise instructions to set the determined one or more configurable firmware variables of the computing system based on reference data. The machine-readable instructions further comprise instructions to control the computing system to apply the set firmware variables during run-time.

### BACKGROUND

Workload management in computing environments, spanning from individual enterprise servers to those of Cloud Service Providers (CSPs), may be a complex challenge. Enterprises running their own servers want to make ensure that their systems are optimized for the specific demands of their applications, balancing factors like CPU usage, memory allocation, and network bandwidth. This may be more complex in CSPs' data centers, where the variety and unpredictability of workloads are significantly higher due to the multitude of clients with different needs and usage patterns. In such multi-tenant environments, CSPs may not only have to manage resources efficiently but also maintain isolation and security between different clients' workloads.

### BRIEF DESCRIPTION OF THE FIGURES

Some examples of apparatuses and/or methods will be described in the following by way of example only, and with reference to the accompanying figures, in which

FIG. 1a illustrates a block diagram of an example of an apparatus;

FIG. 1b illustrates a block diagram of an example of a second apparatus;

FIG. 1c illustrates non-transitory machine-readable storage medium including firmware for a third apparatus;

FIG. 1d illustrates a block diagram of an example of a fourth apparatus;

FIG. 1e illustrates a flowchart of an example of a method 150;

FIG. 2 illustrates a diagram of a of performance optimization middleware according to a previous approach;

FIG. 3 illustrates an example of a computing comprising a BIOS assisted performance middleware;

FIG. 4 illustrates an operational flow of a controller and an evaluator;

FIG. 5 illustrates a flame graph;

FIG. 6 illustrates an example of a processing flow of a BIOS assisted performance middleware;

FIG. 7a illustrates one virtual machine running on an entire socket;

FIG. 7b illustrates multiple virtual machines each running on its own dedicated socket; and

FIG. 7c illustrates multiple virtual machines running the same socket.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

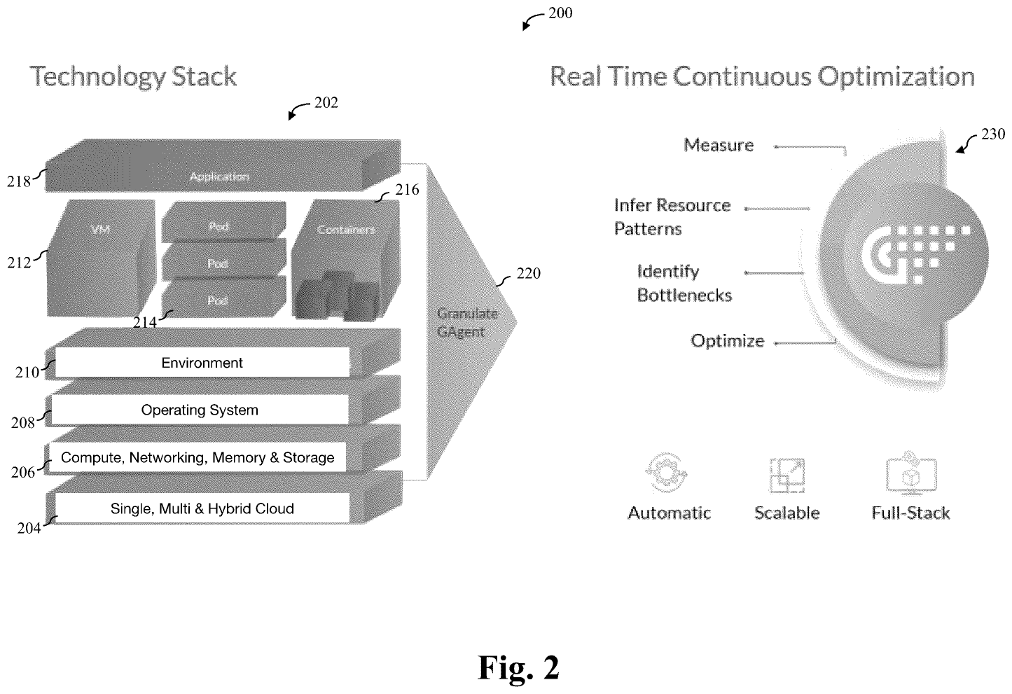

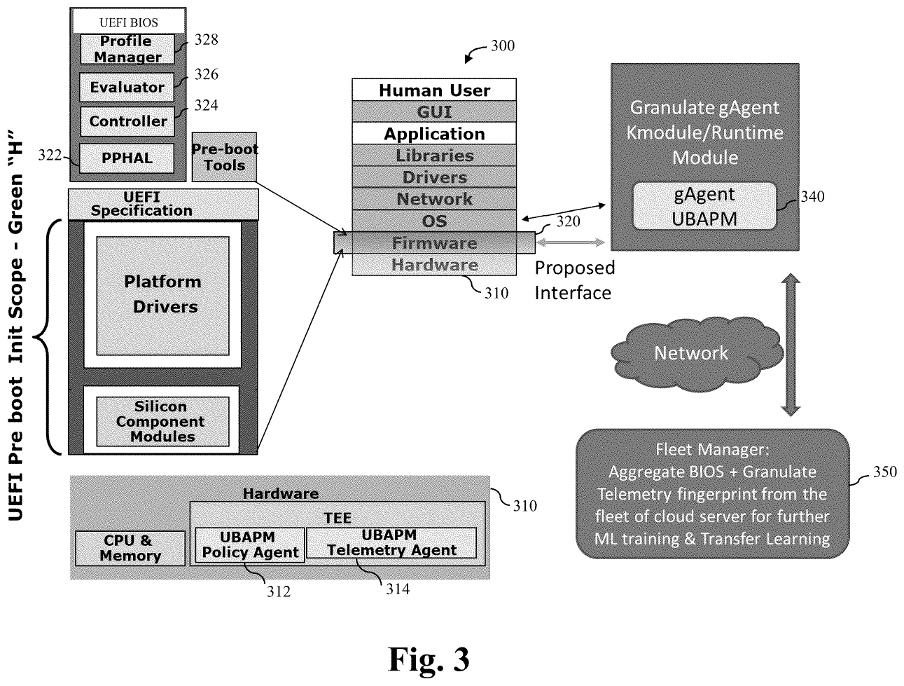

Intel® Granulate™™ middleware may be configured to use publicly defined variables like program counters, architectural Model-Specific Registers (MSR's), e.g., prefetch depth, and other information to do a performance tuning. Granulate™ may be efficiently working with the operating system variables but may be not aware of any BIOS (Basic Input/Output System) variables to optimize workloads. This may be challenge in a public cloud (see FIG. 2).

The herein proposed technique may augment a middleware such as Granulate™™ with BIOS variables access (also referred to as BIOS knows or BIOS_KNOBS) that may make it more effective.

Unified Extensible Firmware Interface (UEFI), is a BIOS framework that standardizes the interface and functionality of a computer's firmware, offering enhanced boot capabilities and security features. For instance, the specification “Advanced Configuration and Power Interface (ACPI) Specification Release 6.5” by the UEFI Forum, Inc, from Aug. 29, 2022, defines a plurality of (configurable) BIOS variables. These BIOS variables comprise variables (also referred to as knobs) that may be boot-time updatable (for example referred to as BIOS_KNOBS_BOOT_TIME) and/or BIOS variables that may be run-time updatable (for example referred to as BIOS_KNOBS_RUNTIME). Further, some BIOS variables may have protection from being visible from other execution modes (e.g., System Management Mode (SMM) or Converged Security and Management Engine (CSME)).

When it is referred to a BIOS variable in the following, this may relate to variables from the document cited above, for example.

In some previous approaches the BIOS variables are opaque to a operating system (OS), a virtual machine monitor (VMM) and a middleware (such as Granulate™), as also shown in FIG. 2 (see below). Therefore, in some approaches the BIOS variables may be tuned manually for instance via setup options during pre-OS. Therefore, specific types of performance benchmarks may be used to evaluate (for instance Intel proxy benchmarks such as SPECint®, Spec Power, etc.). These benchmarks, however, may not be customer workloads and may be based on performance heuristics (such as Intel Reference BIOS on Reference Platform) which may not be scalable to Original Equipment Manufacturers (OEMs)/Original Design Manufacturers (ODMs) platform with an independent software vendor (ISV) for BIOS.

Further, in some approaches the BIOS variables knobs may be hidden in the BIOS and may not be exposed as part of Out-of-the-box (00B) boot and may not be available to end developers and users for instance in a public cloud environment (especially in scenarios with co-existing tenants and reboot is not an acceptable option in the public cloud).

Further, in some previous approaches system and performance optimization is for instance based on tuning system variables (knobs) in architectural MSR's in the Software Developer Manual (SDM) or based on an abstracted method via OS power management (OSPM) such as Advanced Configuration and Power Interface (ACPI), which is a standard for power management and configuration interfaces between an operating system and the hardware. However, beyond the SDM and ACPI, though, there may be a plurality of non-public variables and control/status registers that may be not exposed to operating system vendors (OSV's) and ISV's, and which are often chip-specific. Therefore, there may be room for performance enhancement for certain customer use-cases.

The present disclosures proposes a BIOS (such as UEFI BIOS) assisted performance middleware (also abbreviated as BAPM or UBAPM) that augments performance middleware (such as Granulate™™) with stateful BIOS variables (BIOS_KNOBS) towards performance optimization. Further, this may involve a versioning ability to track and revert settings per workload/virtual machine (VM) instance. Further, this may involve a carrying-forward of settings along with VM instance meta data.

This proposed concept may also provide heuristics and learnings such that if a new set (tuple) of BIOS variables is set, which may have a deleterious effect on performance, the BIOS may have a monitor/learning mode to ascertain the plug-and-play state and potentially revert the change. Therefore, these BIOS variables may have a write ability to set a desired change and also may have a read-capability to see if the setting was successful or is still applicable, including potential statistics. These “set, monitor, revert” set of actions is not known in tracking based (or just setting once in the pre-OS phase without monitoring) approaches.

Further, the proposed concept may implement a seamless BIOS update performed by or based on the middleware (such as Granulate™™) to save the settings and statistics. This BIOS update flow may ensure that a processing circuitry (such as a server or a node) carries these settings long-term and may not need a continual activation. This may be implemented by a bit/attribute which indicates that the setting persists contrary to a mode of making the change only applicable for one boot/session. That is the BIOS assisted performance middleware's according to the present disclosure may be configured with the ability to persist the state, such that it learns/derives the settings from a former that a processing circuitry (such as a server or a node) in order to avoid having to re-learn and imprint an instance. In this regard these settings may be captured in dynamic tunable BIOS profiles. These profiles may be chosen and/or optimized (for example by a virtual machine instance in a public cloud or the like) based on the workload (WL) needs—that is dynamic workload-based tunable BIOS profiles (that is (workload optimized BIOS profiles)—rather than limited by infrastructure provided default OOB experience with hidden BIOS variables not available for WL performance tuning.

Further, a plurality of the BIOS assisted performance middleware's according to the present disclosure may report their statistics (such as chip settings with regards to the achieved performance enhancement or the like) to a central entity so that the central entity may process the data and based on that provide learning and recommendations beyond a single chip (such as a system-on-chip (SoC)) platform instance. This enables learning performance enhancement settings beyond a single chip (such as an SoC) family and providing generational learning, so that over time there may be evolved performance settings.

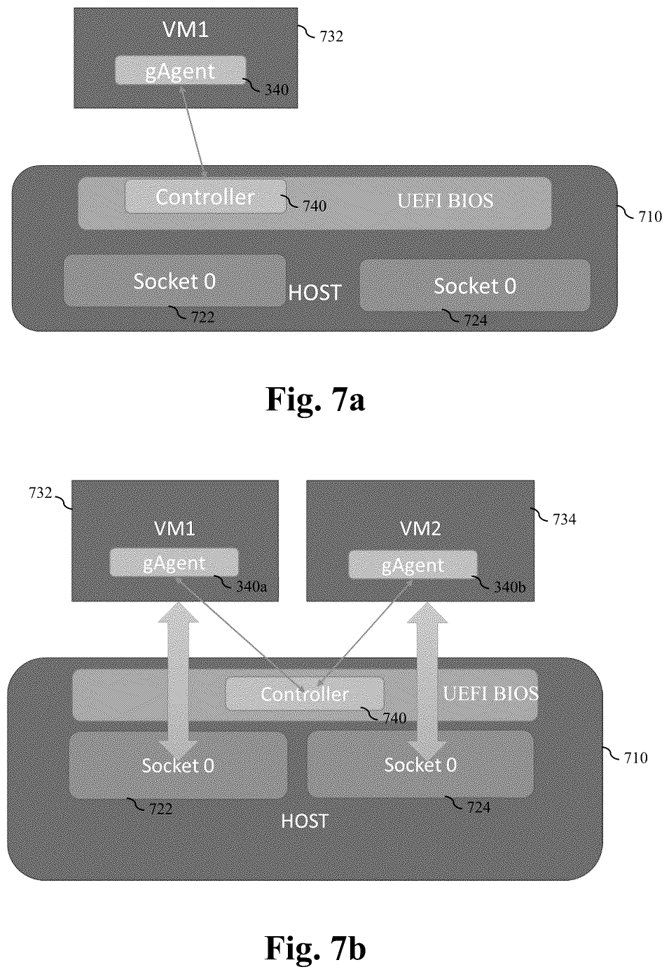

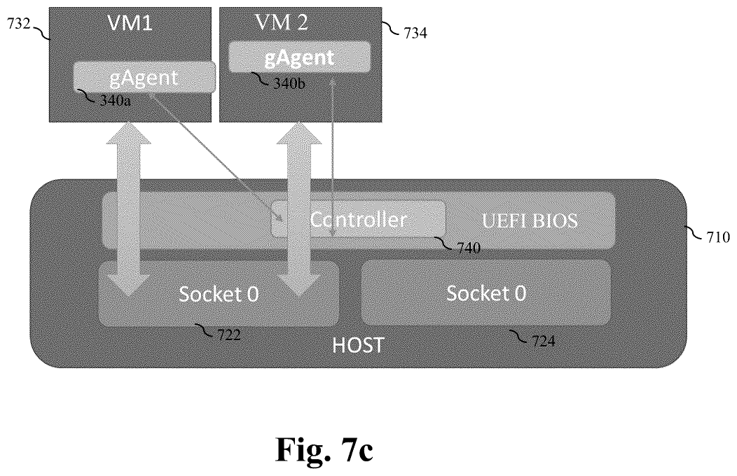

Further, the BIOS assisted performance Middleware's according to the present disclosure may be configured to adapt dynamically to optimize/select appropriate BIOS variables based on a shared socket based on the virtual machine placement information from a hypervisor (see FIGS. 7a-c below).

The proposed technique may leverage available middleware (such as Granulate™™) for instance and a cloud workload performance optimization may be augmented by the proposed technique to have an attested/certified performance profile.

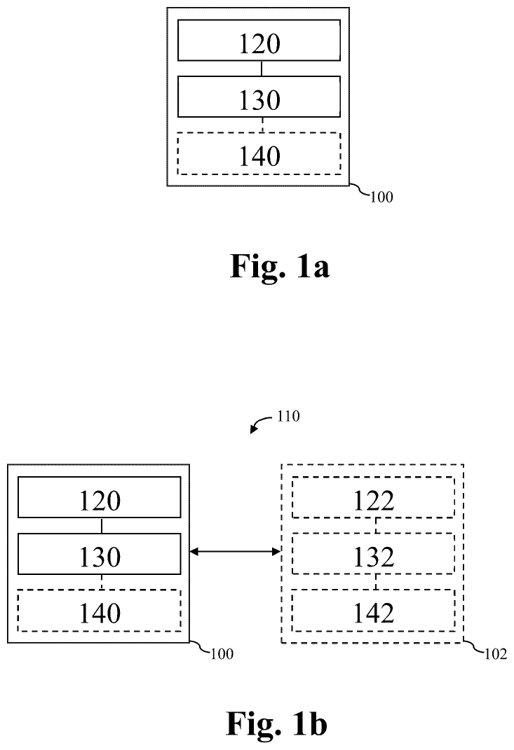

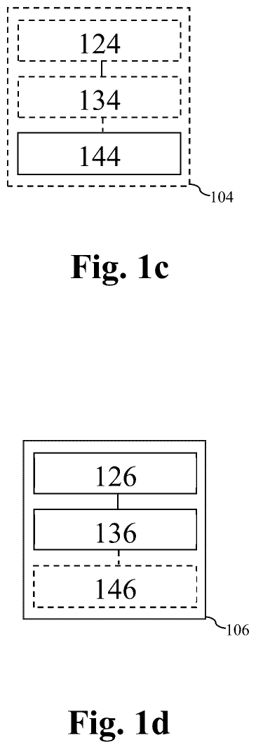

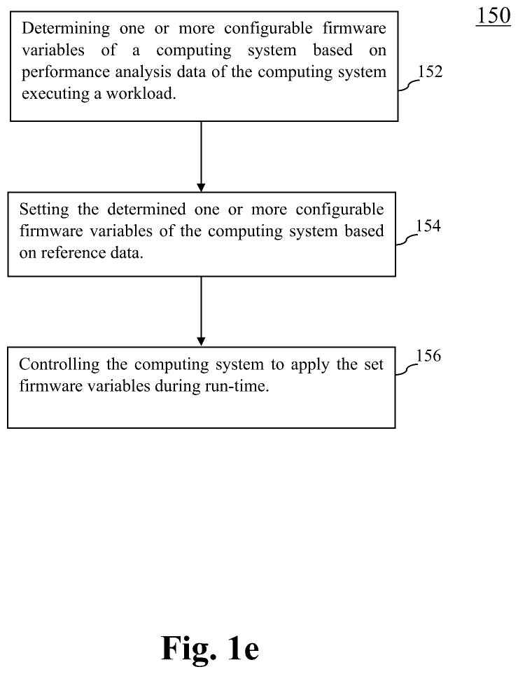

FIG. 1a illustrates a block diagram of an example of an apparatus 100 or device 100. The apparatus 100 comprises circuitry that is configured to provide the functionality of the apparatus 100. For example, the apparatus 100 of FIG. 1a comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1a comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage. For example, the storage circuitry 140 may store a (UEFI) BIOS.

The processing circuitry 130 is configured to determine one or more configurable firmware variables of a computing system based on performance analysis data of the computing system executing a workload. For example, the computing system may be the apparatus 100 which is executing a workload. In another example, the computing system may be a second external apparatus 102 that is connected to the processing circuitry 130 (for example via the interface circuitry 120) which is executing a workload, as illustrated in FIG. 1b. In order to improve the performance of the executing of the workload on the computing system the configurable firmware variables of the firmware of a computing system are set to optimized values.

In some examples, the firmware is a specialized type of software that provides low-level control for hardware of the computing system. For instance, the firmware may be a BIOS (Basic Input/Output System), which initializes and tests hardware components of the computing system during the booting process and/or during the run-time of the computing system. In some examples, the firmware is embedded into the hardware (for example the storage circuitry 140) and acts as the interface between the computing systems hardware and the higher-level software operations. For example, the firmware may be stored in the storage circuitry 140, which is part of the apparatus 100.

In some examples, the firmware is BIOS. In some examples, the BIOS is an UEFI BIOS. The UEFI BIOS may be defined in the standard as cited above (“Advanced Configuration and Power Interface (ACPI) Specification Release 6.5” by the UEFI Forum, Inc, from Aug. 29, 2022). For example, the UEFI BIOS, may be an updated version of a traditional BIOS. UEFI may provide a more modern interface and enhanced features, such as graphical menus and secure boot, and it may support larger hard drives and faster boot times.

In this regard, for instance, a configurable firmware variable is a variable stored in the firmware (such as BIOS or UEFI) that can be modified to alter the behavior and characteristics of the hardware of the computing system. The configurable variables may allow for customization and optimization of system performance and functionality. For example, the one or more configurable firmware variables may be configurable during boot-time and/or during run-time of the computing system (that is the one or more configurable system variables may comprise a runtime or a boot-time variable).

In some examples, the one or more configurable firmware variables may comprise at least one of a memory optimization variable, I/O optimization variable, CPU optimization variable.

In some examples, a configurable BIOS variable may be: Boot order variable, which determines the sequence in which the firmware searches for a bootable device in the computing system; CPU frequency variable, which determines the operating frequency of the CPU; CPU voltage variable, which determines the voltage supplied to the CPU, impacting performance and heat generation; Fan speed variable, which determines the speed of the cooling fans to manage thermal conditions; Integrated peripherals variable, which enables or disables onboard devices; Memory timing variable, which adjusts the timing parameters of the RAM for optimized performance; Power management variable, which configures settings for energy efficiency and power-saving modes; Virtualization support variable, which enables or disables hardware virtualization features. Further, UEFI configurable firmware variables are defined in UEFI standard, for example the UEFI standard cited above.

The workload of the computing system may refer to a set of tasks or operations carried out by the computing system.

Performance analysis data of the computing system executing the workload may be a collection of data comprising metrics and information that is obtained by evaluating the effectiveness and efficiency of the computing system processing its assigned tasks and operations.

Performance analysis data may refer to performance counters telemetry data that indicate bottlenecks observed in the computing system for a given workload in a (for example pre-determined) observatory time window.

The performance analysis data of the computing system executing a workload may comprise data that is obtained by evaluating at least one of the following: A CPU speed evaluation data, RAM capacity evaluation data, RAM speed evaluation data, storage throughput evaluation data, storage latency evaluation data, network bandwidth evaluation data, network latency evaluation data, GPU performance evaluation data, power consumption evaluation data, thermal metrics evaluation data, and fan speeds evaluation data. Analyzing these specific parameters may provide a comprehensive view of the computing system's performance. This may enable targeted optimizations for enhanced efficiency and reliability.

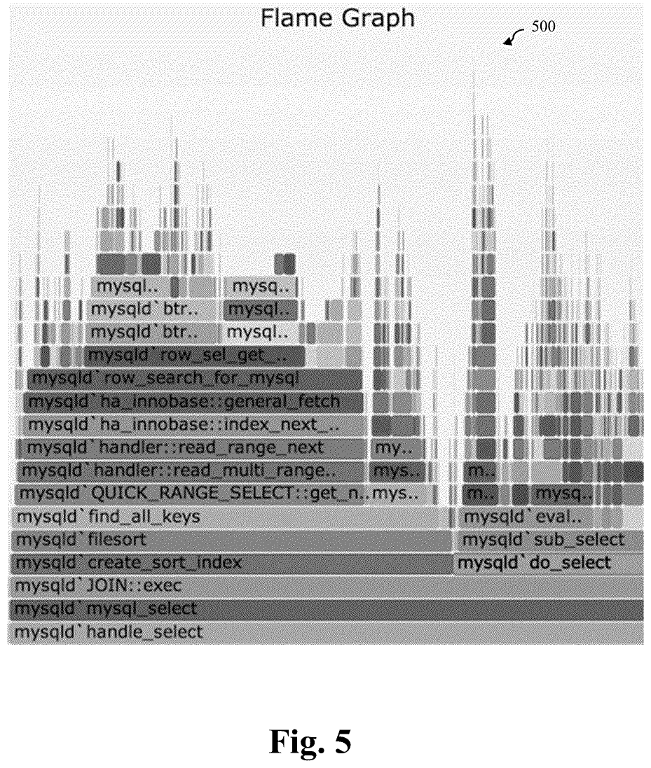

In some examples, the performance analysis may be based on or comprise a flame graph (see FIG. 5 below). Additionally, or alternatively the performance analysis hardware may involve the usage of profiling and tracing software tools employed to collect and analyze performance data.

In some examples, the processing circuitry 130 may be configured to determine a profile of firmware variables, comprising a plurality of pre-determined configurable firmware variables of the computing system based on the performance analysis data of the computing system executing a workload. A profile of firmware variables may comprise a set of pre-determined configurable firmware that may be internally connected to each other such that they have a common optimization target or are based on the same or similar hardware components. For instance, there may be a profile for computation optimization, a profile for memory optimization, a profile for I/O optimization, a profile for non-uniform memory access optimization or the like.

Further, the processing circuitry 130 is configured to set the determined one or more configurable firmware variables of the computing system based on reference data. The setting of the of the one or more configurable firmware variables may comprise setting each of the one or more configurable firmware variables to a specific (numeric) value.

In some examples, the setting may be based on an optimization process where a (local or global) optimal setting is determined. Further, the setting may involve reference data. For instance, the optimization may be carried out in a space that is based in the reference data.

In some examples, the reference data may comprise at least one of application quality of service data for the workload, policy rules for the workload Cor previous firmware variable settings. For example, the determined one or more configurable firmware variables are set to values which they were set previously. For example, to values they were set previously on similar performance analysis data. In some examples, the one or more configurable firmware variables are set to values or values within intervals which are pre-determined by policy rules and/or quality of service constraints. In some examples, policy rules may comprise privacy preservation rules, telemetry abstraction rules or the like. In some examples, the quality of service (QoS) may comprise at least one of the following: Latency/response time (machine learning (e.g., AI) model's response time in milliseconds for a query), maximum throughput that may be delivered (e.g., max frames per second encoded).

In some examples, the reference data may comprise tuple of records as a combination of the set of firmware variables along with the operating system/virtual machine manager/middleware variables for performance, power tuning that may help the workload to meet a required QoS without violating any of the configurable provisioned policy rules (for example provisioned by an administrator, or fleet manager or the like).

In some examples, the processing circuitry 130 may be configured to set the determined one or more configurable firmware variables based on a trained machine learning model. For instance, previous firmware variable settings from the computing system and/or further computing systems are used by the machine learning algorithm or the like to determine a (optimized) setting (value) for each of the one or more firmware variables, which may then be used as the reference data.

In some examples, the reference data comprises a profile of reference values for the one or more configurable firmware variables. For example, if a profile of firmware variables was determined to be set, then the variables in this profile may be set according to a corresponding profile of reference values. For instance, if a profile for computation optimization is determined to be set, then the variables may be set according to a profile of reference values for computation optimization. For instance, if a profile for memory optimization is determined to be set, then the variables may be set according to a profile of reference values for memory optimization. For instance, if a profile for I/O optimization is determined to be set, then the variables may be set according to a profile of reference values for I/O optimization.

In some examples, the one or more configurable firmware variables comprise one or more authenticated firmware variables. That is, the one or more authenticated firmware variables can only be set by the processing circuit 130 or another entity if it can authenticate that it is allowed to set the firmware variables. For example, there may be a password or (cryptographic) key that must be entered or presented in order to be allowed to set the firmware variable. One or some or all firmware variables can be authenticated with different or the same authentications and can have a permission for one or more different entities.

Further, the processing circuitry 130 is configured to control the computing system to apply the set of firmware variables during run-time. The setting and applying of the one or more firmware variables may also be referred to as updating of the one or more firmware variables.

The above (and below) disclosed concept may also be referred to as the firmware assisted performance middleware, or in case that the firmware is a UEFI BIOS, as the UEFI BIOS assisted performance middleware (UBAPM). The term middleware may refer to a layer between firmware and operating system (software).

The proposed concept may have the advantage that the workload may be executed faster and more efficiently with the optimized firmware variables. Further, the firmware variables may be set to workload optimized values faster because no re-boot of the computing system may be necessary for setting the variables. Therefore, for example, for each new workload the firmware variables may be set to different values, without re-booting the computing system. This may yield an optimized and faster executing of workloads by the computing system.

In some examples, the processing circuitry 130 may be configured to evaluate a performance of the computing system executing the workload with the applied set one or more firmware variables. In some examples, the performance of the computing system executing the workload may be evaluated by obtaining the same performance analysis data of the computing system executing the workload as described above, however this time with the (newly updated) applied set one or more firmware variables.

In some examples, the performance of the computing system executing the workload with the applied one or more firmware variables is evaluated in comparison to the performance analysis data that was obtained before updating the one or more firmware variables. For example, if a difference between these two performance analysis data is exceeding a certain threshold, it may indicate that the quality of the applied one or more firmware variables is acceptable or not acceptable.

In some examples, the processing circuitry 130 is further configured to store the data of the performance evaluation of the computing system executing the workload with the applied set one or more firmware variables.

In some examples, the processing circuitry 130 may be further configured to apply a machine learning algorithm based on the data of the performance evaluation of the computing system executing the workload with the applied set one or more firmware variables. This may yield a reference data for the one or more configurable firmware variables. For example, the performance analysis data with the applied one or more firmware variables and/or performance analysis data that was obtained before updating the one or more firmware variables may be used as input to the machine learning algorithm. As described above the reference data that is obtained based on the machine learning algorithm, may be used to set the determined one or more configurable firmware variables of the computing system.

In some examples, the processing circuitry 130 may be further configured to verify if the firmware variables are within a policy constraint and control the computing system to apply the set one or more firmware variables during run-time if the verification is successful. For example, the policy constraint defines an interval (or a fixed value) within which the values of one or more firmware variables of the one or more firmware variables must be set. This may be due to hardware restrictions of the computing system or due to aspects with regards to the workload that is executed (for example safety aspects of the workload that is executed or the like). If the processing circuitry 130 succeeds to verify (for example if the policy constraints are met by the one or more firmware variables) the requested setting of the one or more configurable firmware variables (which may set during an optimization process or the like) then the setting of the one or more configurable firmware variables are applied during run-time. If, however, the processing circuitry 130 determines that verification fails, then policy-based action may be taken by the processing circuitry 130. This may comprise to shift the setting of the one or more configurable firmware variables to the nearest value that fulfills the policy constraints or to leave the one or more configurable firmware variables at their current value or set to a predetermined default value or the like.

In some examples, the processing circuitry 130 may be further configured to reset the one or more firmware variables that were previously set and applied (i.e., updated) to a default value after the workload or a certain number of workloads is carried out or after a specified amount of time elapsed.

In some examples, the processing circuitry 130 may be further configured to apply the set one or more firmware variables to the computing system for the executing of one or more further workloads, that is after finishing the current workload (on which the updating of the one or more firmware variables was based).

In some examples, the updated values of the one or more firmware variables will persist a certain number of workloads or a specified amount of time and is however re-set to a default value during re-boot of the computing system.

In some examples, the processing circuitry 130 is further configured to apply the one or more firmware variables to the computing system such that they persist after one or more re-boots of the computing system. This may be implemented for example, by a corresponding bit (or an attribute) for each firmware variable. For example, said bit may be set to “0” if the update shall persist after a re-boot and to “1” if the firmware variable shall be set to a default value after re-boot (or vice versa). With this ability to persist the state, the firmware may learn/derive the firmware settings from a former computing system (node) in order to avoid having to re-learn and imprint an instance.

In some examples, the processing circuitry 130 is configured with a versioning ability with regards to the applied set one or more firmware variables. That means that the applied set firmware variables may be reverted to a previous and/or default value if a updated firmware variable does not yield the desired performance results or causes problems.

In some examples, the processing circuitry 130 may be further configured to receive the data of a performance evaluation of one or more second computing systems executing one or more second workloads with one or more second applied set firmware variables. Further, the processing circuitry 130 may be configured to apply a machine learning algorithm based on the data of the performance evaluation of the one or more second computing systems yielding reference data for the one or more configurable firmware variables.

For example, the processing circuitry 130 may be further configured to train the machine learning algorithm based on the data of the performance evaluation of one or more second the computing systems.

In other words, apparatus 100 (for example the processing circuitry 130) or the second apparatus 102 (for example the second processing circuitry 132) may aggregate the telemetry data across one or many computing systems (for example cloud servers in a fleet) to feed a dataset which is used by a machine learning algorithm to obtain (optimized) settings for one or more of the one or more firmware variables. Thereby, the leanings from one computing system may be leveraged and transferred to other computing system. In some examples, instead of one or more firmware variables firmware profiles may be aggregated and learned by the machine learning algorithm.

In another example, the receiving of the data of a performance evaluation of the one or more second computing systems and/or the applying/training of the machine learning algorithm based on the data of the performance evaluation of the one or more second computing systems (which yields the reference data for the one or more configurable firmware variables) may be carried out by the second apparatus 102 (for example the second processing circuitry 132). The obtained reference data for the one or more configurable firmware variables may be communicated to the processing circuitry 130 (for example via the interface circuitry 120).

In some examples, the processing circuitry 130 is further configured to run one or more virtual machines on the computing system, wherein the workload executed by the computing system is a workload of the virtual machine.

A virtual machine (VM) may be a software-based emulation of a physical computer, creating an environment that can execute its own operating system and applications as if they were running on a separate physical machine. VMs may be operated on a layer above the actual hardware (see also FIGS. 2 and 7) and are managed by a Virtual Machine Monitor (VMM) (also referred to as hypervisor). The VMM, which can be either Type 1 (bare-metal), running directly on the hardware, or Type 2 (hosted), operating on top of a host operating system, orchestrates the creation, execution, and management of these VMs. It allocates physical resources such as CPU, memory, and storage to each VM and ensures that they are isolated from one another, maintaining both security and stability. In some examples, multiple VMs (potentially with different operating systems and configurations) may be run concurrently on a single physical machine, maximizing resource utilization and providing flexibility in deployment and testing scenarios. The VMM thus plays a critical role in virtualization, acting as the control layer that enables the virtualization of hardware and the efficient operation of VMs.

For instance, the computing system may be server operated by a cloud service provider. For example, a plurality of VMs is operated by the cloud service provider on the computing system.

In some examples, the one or more virtual machines may be configured to set the determined one or more configurable firmware variables of the computing system based on reference data and to control the computing system to apply the set firmware variables during run-time. That is the one or more virtual machines (also referred to as virtual machine instances) running on the computing system, which may be regarded as an independent (emulation of an) computing system, may perform the determining and setting and/or applying of the configurable one or more firmware variables (or firmware profile) with regards to the workload that is executed by the corresponding VM. Further, all the above-described examples and techniques may be applied with regards to a virtual machine that is running on the computing system instead of a workload. The VM may be considered as the workload that is carried out by the computing system. That is for example, the set one or more firmware variables (or firmware profiles) may be applied with regards to a VM and all the workloads and tasks that are executed by the VM.

In some examples, the one or more virtual machines may be controlled by a hypervisor, the hypervisor being configured to set the determined one or more configurable firmware variables of the computing system based on reference data and to control the computing system to apply the set firmware variables during run-time.

That is the hypervisor (VMM) that is controlling the one or more virtual machines running on the computing system, may perform the determining and setting and/or applying of the configurable one or more firmware variables (or firmware profiles) with regards to the workload that is executed by the each of the corresponding VMs. Further, all the above-described examples and techniques may be applied with regards to a virtual machine that is running on the computing system and controlled by the VMM instead of a workload.

Therefore, the VMs controlled by the VMM may be considered as the workload that is carried out by the computing system. That is for example, the set one or more firmware variables (or profiles) may be applied with regards to a VM and all the workloads and tasks that are executed by the VM.

Therefore, the above-described technique may be used to carry-forward the applied set one or more firmware variables (and/or firmware profiles) settings along with an VM instance and/or meta-data. Further, the (dynamic workload based tunable) firmware profiles may be chosen by a VM instance in a public cloud based for example on workload needs (rather than limited by infrastructure).

In some examples the reference data and/or the set one or more firmware variables is/are embedded with a configuration data for each of the one or more of the virtual machines. In some examples the reference data is embedded with a configuration data of the VMM for each of the virtual machines. The reference data may be derived, as explained above, based on the QoS, workload performance telemetry and/or within a policy. Because the set one or more firmware variables and/or reference data is embedded with the VM configuration data, when a VM is migrated to a new environment, the system computing may apply the existing embedded optimal firmware variable settings to start with, and then may further fine tune the firmware variables based on learning on the new environment or the like.

In some examples, the processing circuitry 130 may be further configured to determine one or more configurable system variables of the computing system based on the performance analysis data of the computing system executing a workload. Further, the processing circuitry 130 may be further configured to set the determined one or more configurable system variables of the computing system based on reference data. Further, the processing circuitry 130 may be further configured to control the computational system to apply the set one or more system variables during run-time.

The operating system may be for example Microsoft® Windows®, Apple® macOS® or Unix based operating systems or the like. For example, the one or more system variables may comprise one of the following: CPU scheduling parameters; memory management settings; I/O scheduling and management parameters; network settings adjustments; power management settings; management of system services and background processes; registry settings (specific to Windows®), 8. kernel parameters (specific to Unix-based).

In some examples the one or more configurable system variables may comprise a runtime or a boot-time variable.

Further details and aspects are mentioned in connection with the examples below. The example shown in FIG. 1a may include one or more optional additional features corresponding to one or more aspects mentioned in connection with the proposed concept or one or more examples described below (e.g., FIGS. 1b-7c).

FIG. 1b illustrates a block diagram of an example of an apparatus 102 or device 102. The system 110 comprise the apparatus 100 (see FIG. 1a) and the second apparatus 102. The second apparatus 102 comprises circuitry that is configured to provide the functionality of the apparatus 102. For example, the second apparatus 102 may comprise second interface circuitry 122, second processing circuitry 132 and/or second storage circuitry 142. The components of the second apparatus 102 may be implemented different or similar as the components of the apparatus 100.

For example, the computing system may be the second apparatus 102 that is connected to the processing circuitry 130 (for example via the interface circuitry 120) of the first apparatus 100.

In another example, the BIOS may be stored in a second apparatus 102 (for example on the second storage circuitry 142), which is connected to the first apparatus 100 and the processing circuitry 130 of the first apparatus 100, for example via the interface circuitry 120 of the first apparatus.

Further details and aspects and examples mentioned in connection with FIG. 1a also apply to FIG. 1b accordingly. The example shown in FIG. 1b may include one or more optional additional features corresponding to one or more aspects mentioned in connection with the proposed concept or one or more examples described above (e.g., FIG. 1a) or below (e.g., FIGS. 1c-7c).

FIG. 1c illustrates non-transitory machine-readable storage medium 144 including firmware for a third apparatus 104 (for example a computing system). The firmware comprises one or more configurable firmware variables, the one or more configurable firmware variables being configured to be changed during run-time of the third apparatus 104 based on performance analysis data of the third apparatus 104 executing a workload.

For example, non-transitory machine-readable storage medium 144 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

For example, firmware may be BIOS, for instance a UEFI BIOS.

In some examples the third apparatus 104 may further comprise third interface circuitry 124 and/or third processing circuitry 134. The components of the computing system 104 may be implemented different or similar as the components of the apparatus 100.

Further details and aspects and examples mentioned in connection with FIGS. 1a, 1b also apply to FIG. 1c accordingly. The example shown in FIG. 1c may include one or more optional additional features corresponding to one or more aspects mentioned in connection with the proposed concept or one or more examples described above (e.g., FIGS. 1a, 1b) or below (e.g., FIGS. 1d-7c).

FIG. 1d illustrates a block diagram of an example of a fourth apparatus 106. The fourth apparatus 106 comprises circuitry that is configured to provide the functionality of the apparatus 106. For example, the fourth apparatus 106 of FIG. 1d comprises fourth interface circuitry 126, fourth processing circuitry 136 and (optional) fourth storage circuitry 146. For example, the fourth processing circuitry 136 may be coupled with the fourth interface circuitry 126 and optionally with the fourth storage circuitry 146. The components of the fourth apparatus 106 may be implemented different or similar as the components of the apparatus 100.

For example, the fourth processing circuitry 136 is configured to determine configurable operating system variables of a computing system based on a performance analysis of the computing system executing a workload. Further, the fourth processing circuitry 136 is configured to set the determined configurable operating system variables based on reference data. Further, the fourth processing circuitry 136 is configured to control the computing system to apply the set operating system variables during run-time.

Further details and aspects and examples mentioned in connection with FIGS. 1a-c also apply to FIG. 1d accordingly. The example shown in FIG. 1b may include one or more optional additional features corresponding to one or more aspects mentioned in connection with the proposed concept or one or more examples described above (e.g., FIGS. 1a-c) or below (e.g., FIGS. 1e-7c).

FIG. 1e illustrates a flowchart of an example of a method 150. The method 150 may, for instance, be performed by an apparatus as described herein, such as apparatus 100, the second apparatus 102, the third apparatus 104 and/or the fourth apparatus 106. The method 150 comprises determining 152 one or more configurable firmware variables of a computing system based on performance analysis data of the computing system executing a workload.

The method 150 further comprises setting 154 the determined one or more configurable firmware variables of the computing system based on reference data. The method 150 further comprises controlling 156 the computing system to apply the set firmware variables during run-time.

More details and aspects of the method 150 are explained in connection with the proposed technique or one or more examples described above, e.g., with reference to FIGS. 1a-d. The method 150 may comprise one or more additional optional features corresponding to one or more aspects of the proposed technique, or one or more examples described above or below.

In the following different examples of the proposed concept are given. The examples may be combined among each other and/or with the examples of the FIGS. 1a-1e given above.

FIG. 2 illustrates a diagram 200 of a of performance optimization middleware according to a previous approach. A computing system (for example a server) is modelled and illustrated as a technology stack 202. The technology stack 202 comprises a cloud computing layer 204 (i.e., the abstracted resources provided by a cloud service provider). It may be a single cloud which may refer to services used from one cloud provider, a multi-cloud which may refer to services used from multiple cloud providers or a hybrid cloud which may refer to combined on-premises infrastructure). Further, the technology stack 202 comprises a compute, networking, memory, and storage layer 206 which comprises virtualized resources essential for computing, networking, data communication, memory management and the like. Further, the technology stack 202 comprises an operating system layer 208. The operating system (for instance UNIX based or the like) that is a software layer that manages (virtualized) resources. Further, the technology stack 202 comprises an environment layer 210 (for instance Docker™, or Kubernetes™) which may be a managed ecosystem where applications are developed, deployed, for instance running within containers or orchestrated container clusters. Further, the technology stack 202 comprises a virtual machine layer 212 which generates and maintains one or more virtual machines. Further, the technology stack 202 comprises a one or more pod layers 214, which may be a smallest deployable unit (for instance in or Kubernetes™™) that can be created and managed, usually. Further, the technology stack 202 comprises one or more containers 216 which may be lightweight, standalone, executable software packages that include everything needed to run a piece of software, including the code, runtime, system tools, libraries, and settings. Further, the technology stack 202 comprises an application layer 218 which may be highest layer, comprising end-user software designed for specific tasks or functions. A middleware for performance optimization 220 (for instance Granulate™ gAgent) is aware of layers 204 to 218 and may perform a performance optimization 230 on a task executing on the computing system. The performance optimization 230 on a task executing on the computing system may comprise measuring, inferring resource patterns, identifying bottlenecks and optimization. However, the middleware for performance optimization 220 (for instance Granulate™ gAgent) may be aware of all the layers 204 to 218, but which are all software layers, without direct tunable access to any firmware (BIOS) or hardware, which means the middleware for performance optimization 220 is unaware of BIOS optimization variables.

FIG. 3 illustrates an example of a computing 300 comprising the BIOS assisted performance middleware as proposed in this disclosure. The computing system 300 is modelled as a technology stack, comprising the following layers: Hardware 310, firmware 320, operating system (OS), network, drivers, libraries. Application, graphical user interface (GUI) and a human user layer. The hardware layer 310 is illustrated in more detail in the left bottom of the figure. The hardware layer 302 may comprise a processing circuitry such as an CPU and a memory, a trusted execution environment (TEE) which may comprise a policy agent 312 for the BIOS assisted performance middleware (UBAPM) and a telemetry agent 314 for the for the BIOS assisted performance middleware (UBAPM). The firmware 320 is illustrated in more detail in left side of the figure. The firmware 320 may comprise UEFO BIOS components, that is a platform performance hardware abstraction layer (PPHAL) 322, a controller 324, an evaluator 326 and a profile manager 328. Further, the firmware may comprise a pre-boot controller and a firmware specification (for example an UEFI specification, for example the specification reference above). Furthermore, the computing system is comprising the BIOS assisted performance middleware 340 (for instance the gAgent UBAPM). Further, the BIOS assisted performance middleware 340 may be coupled, for instance via a network, to a fleet manager 350. The fleet manager 350 may collect and aggregate telemetry data of a plurality of BIOS assisted performance middlewares from computing systems and perform machine learning training and transfers the obtained learning results to each of the BIOS assisted performance middlewares. The proposed concept may comprise parts or all of the following components working together: The policy agent 312 for the BIOS assisted performance middleware (UBAPM), a telemetry agent 314 for the for the BIOS assisted performance middleware (UBAPM), the platform performance hardware abstraction layer (PPHAL) 322, the controller 324, the evaluator 326 and the profile manager 328 and the BIOS assisted performance middleware 340 (for instance the gAgent UBAPM).

The firmware components will be described in more detail now: The PPHAL 322 is an abstraction layer, that abstracts the BIOS variables in a trusted environment (for example using authenticated variables) and in an un-trusted environment. This may further provide the capability to emulate variables that are not yet defined in the BIOS specification but may be potentially introduced in future.

The profile manager 328 is a component of the UEFI BIOS. The profile manager 328 defines a set of configurable UEFI variables (for example variables are a GUID:UnicodeString:DataPayload tuple). For example, the defined BIOS variables may comprise variables for computation optimization (ComputeOptimized), variables for memory optimization (MemoryOptimized), variables for I/O optimization (IoOptimized), variables for non-uniform memory access optimization (NumaOptimized) or the like. Further, the defined configurable BIOS variables may have properties that comprise, boot-time, runtime, or the like. The variables may be exposed to the operating system of the computing system 300, for instance via Win32 as SetEnvironmentVariable( ) in Windows® call or via/proc/efi/var interface in Linux®.

In some examples configurable BIOS variable setting may be performed by a guest virtual machine running on the computing system 300. In this case the guest firmware may do the setting itself if the hardware resource of the computing system 300 is exposed to guest; or the guest firmware may send to the hypervisor and then call the firmware of the computing system (also referred to as bare metal firmware) via an EFI (Extensible Firmware Interface) API; or the guest firmware may proxy to a system management interrupt (SMI) and have a BIOS system management mode (SMM) performing the BIOS variable setting. However, a “set variable” API may be the unique surface area exposed.

Further, the profile manager 328 may provide heuristics and learnings to the BIOS assisted performance middleware 340. For example, if a new BIOS variable (for example a tuple of KNOB's) is set and may have a negative (for example a deleterious) effect on the performance, the BIOS (for example the controller 324 and/or the evaluator 326) may have a monitor/learning mode to ascertain the plug-and-play state and potentially revert the change. In another example the configured BIOS variables may have a write ability to set a desired change and/or a read-capability to monitor if the setting was successful or is still applicable, including potential statistics.

In some examples, the configurable BIOS variables have attributes referring the CPU's, the physical range of memory, I/O ranges or the like such that performance is performed at a subsocket, compute express link (CXL)/peripheral component interconnect (PCI) affinity. These BIOS variable are special BIOS managed variables (e.g., SOC/chipset specific, or non-public MSR, memory mapping—1:1 versus Non-Uniform Memory Access). These settings complement the grosser, more static settings like Resource Director Technology (RDT) and Cache Allocation Technology (CAT) or the like. This may apply to different BIOS firmwares like UEFI and others.

In some examples, the defined BIOS variables may be authenticated variables, so that only specific (authenticated) trusted entities (such as Granulate™ binary) are allowed to perform the variable setting call. This may avoid malware from abusing the BIOS variables and ensures that only licensed code behavior is allowed to perform the adjustment for services like Platform Performance as a Service (PPerfAAS) versus public CPU only CPU Performance as a Service (CPerfSAS).

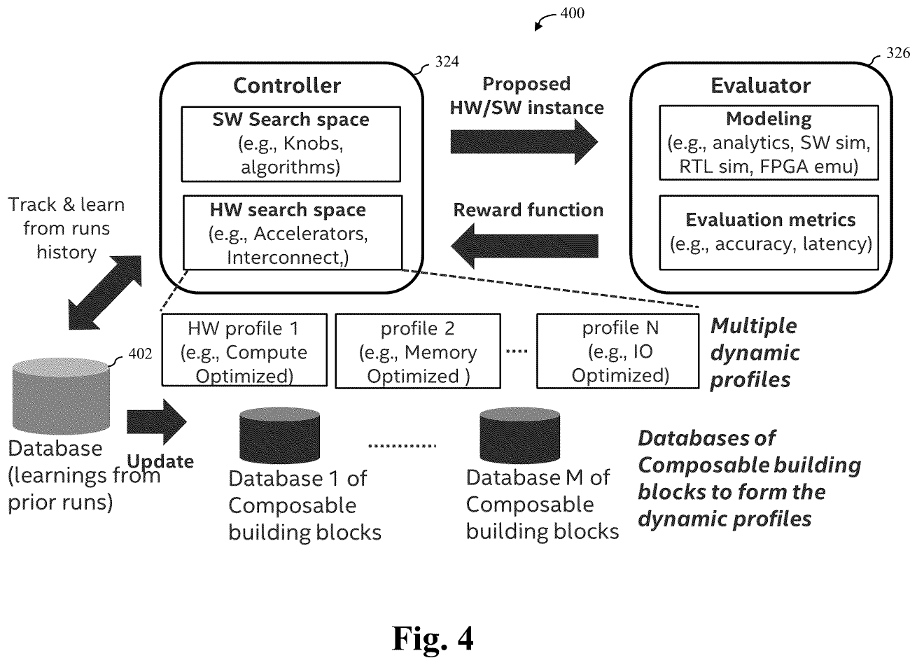

The controller 324 may provide the capability to enforce real-time policies on the exported run-time variables via in-band or 00B TEE/baseboard management controller (BMC) conduit (see also FIG. 4). The controller may be considered as a component of the profile manager 328.

The evaluator 326 may provide real-time telemetry data on the configured BIOS variable profile usage (see also FIG. 4). The controller may be considered as a component of the profile manager 328.

The BIOS assisted performance middleware 340 (for example the Granulate™™ gAgent UBAPM) may be part of a kernel module/runtime module. In some examples, the BIOS assisted performance middleware 340 may augment an already existing performance middleware with access to BIOS variables. The BIOS assisted performance middleware 340 may store the relevant BIOS variables that may help/hurt a particular workload and/or a particular virtual machine under consideration and running and being executed on the computing system 300 along with telemetry statistics. For instance, an update of the BIOS variables may ensure that the computing system (for example the node) carries these BIOS variable settings long-term and does not need a continual activation. This may be implemented by a bit/attribute that defines “persist” versus a mode of making the change only applicable for example for one or some boot/session. With this ability to persist the state (configured BIOS variables) the BIOS assisted performance middleware 340 may learn and/or derive settings from another node and may thereby avoid having to re-learn and imprint an instance.

In some examples, a plurality of instances of the BIOS assisted performance middleware 340 (which may run the computing system 300 or on other computers) report back their BIOS variable settings along with chip settings and telemetry data to a central entity (for example to the fleet manager 350). The central entity may provide advanced learning and recommendations beyond a single chip platform instance (such as one SoC). This enables learning performance enhancement settings beyond a single chip (such as an SoC) family and providing generational learning, so that over time there may be evolved performance settings (see also FIGS. 7a-7c).

FIG. 4 illustrates an operational flow 400 of the controller 324 and the evaluator 326. The controller 324 and the evaluator 326 may be considered as (sub-)components of the profile manager 328. Based on provisioned policies (configurable) the controller 324 may search a software (SW) search space, that comprises for example configurable software variables (Knobs), such as operating system software variables and tunable algorithms. Further, the controller 324 may search a hardware (HW) space for suitable configurable BIOS variables, such as accelerator variables or interconnect variables, as described above. The controller 324 may further search the hardware (HW) space for suitable hardware profiles, such as a hardware profile 1 (HW profile 1) which is compute optimized, or hardware profile 2 (HW profile 2) which is memory optimized, or hardware profile 3 (HW profile 3) which is I/O optimized. The controller 324 may retrieve data from a database 402. The database 402 has retrieved, processed (for example running a machine learning algorithm) and stored prior database learnings to form dynamic hardware profiles that can be recommended for a current workload/tenant of the computing system at run-time. The database 402 further may access and update databases 1 to M which comprise composable building blocks to form dynamic profiles. The hardware search space exploration may be done based on the results of a performance analysis of the computing system carrying out a workload. The performance analysis may be done as explained an illustrated in a flame graph, see FIG. 5. Additionally, or alternatively the hardware space search may be done by profiling and tracing software tools employed to collect and analyze performance data.

FIG. 5 illustrates a flame graph 500. A flame graph is a visualization of hierarchical data, created to visualize stack traces of profiled software so that the most frequent code-paths to be identified quickly and accurately. That is a flame graph a represents the relative time functions or methods (also referred to as workload) take to execute (for example on the computing system 300) and helps in identifying the most time-consuming parts of the code. By visually aggregating similar call stacks, flame graphs allow for efficient identification of performance bottlenecks, as the most resource-intensive paths appear as wider sections or “flames”, making them easily distinguishable. Therefore, a flame graph and the methods used to generate it, may be used for identifying the variables in the BIOS that may be tuned for improved performance of the computing system executing a workload. The x-axis of the flame graph 500 shows the stack profile population (for example sorted alphabetically). The y-axis of the flame graph 500 shows stack depth, counting from zero at the bottom. Each rectangle in the flame graph 500 represents a stack frame. The wider a frame is, the more often it was present in the stacks. The top edge of the flame graph 500 shows what is on-CPU, and beneath it is shown its ancestry. Generating and utilization of flame graphs is also explained in the paper “The flame graph.”, by Gregg, Brendan, published in Communications of the ACM 59.6, 48-57, year 2016.

Back to FIG. 4. The controller 324 may then propose the searched and determined hardware/software variables and/profiles to the evaluator 326. The evaluator 324 may police if the secured recommended hardware/software variable/profile is behaving within the provisioned policies and/or quality of service (QoS) constraints and may take necessary policy-based actions. Therefore, the evaluator 326 may model the computing system and the configured BIOS variables/determined profiles. This may comprise for instance the performing of analytics, software simulations, Register-Transfer Level (RTL) simulations, FPGA emulations and the like. Further, the evaluator 326 may evaluate the metrics of the modeling and/or of the application of the configured BIOS variables/determined profiles such as the accuracy or latency of the carried-out workload. Further, the evaluator 326 provide a reward (function) of the configured BIOS variables/determined profiles back to the controller 324, which may apply machine-learning based techniques based on the reward for future improvements.

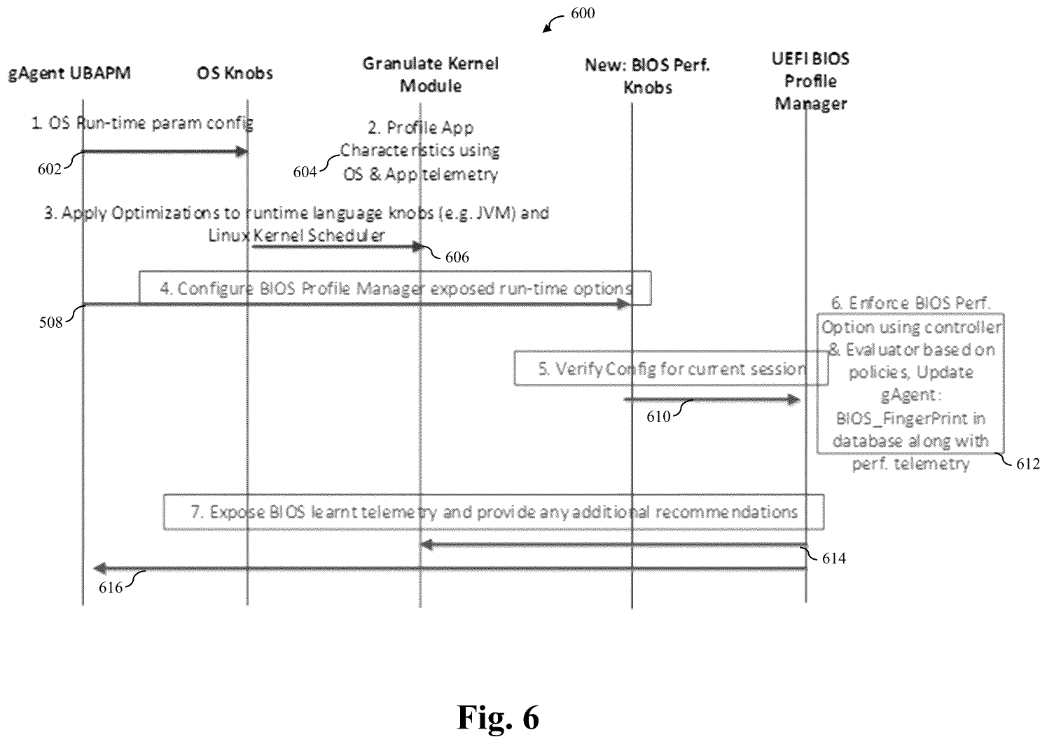

FIG. 6 illustrates an example of a processing flow 600 of the BIOS assisted performance middleware 340. In step 602 the BIOS assisted performance middleware 340 (for example the gAgent of the UBPAM) may explore potential configurable operating system (OS) run-time variables (knobs), which are available for the tenant/virtual machine on a given hypervisor/VMM of the computing system 300. In step 604 OS variables and/or profile application characteristics are determined in terms of run-time languages (such as Java virtual machine (JVM)/web assembly (WASM)) to identify parameters for tuning along with a potential kernel-scheduler changes based on machine-learning based recommendations received from an online fleet manager. In step 606 the determined OS variables and/or profiles are applied for optimization of the workload carried out by the computing system to a run-time language management engine as well as to a kernel scheduler (for example the Linux® Kernel Scheduler). In step 608 the BIOS assisted performance middleware 340 may determine and configure the BIOS variables (BIOS knobs), for example based on application QoS, telemetry and/or BIOS telemetry from a past fingerprint. Therefore, the performance profile manager may expose potential BIOS variables (hardware knobs) which aren't available to the operating system (see steps 602, 604, 606) but which may be applied to specific virtual machine cores under consideration for the current virtual machine/tenant of the computing system 300 without a reboot. The determination of the configurable BIOS variables and/or profiles may be performed based on hardware search space exploration, for example based on a flame graph as described above with regards to FIGS. 4 and 5. In step 610 the requested configured BIOS variables and/or profiles from step 608 may be verified for the current session and/or current workload. If this verification succeeds it is continued with step 612 and the configured BIOS variables and/or profiles may be enforced. If verification fails, policy-based actions may be taken. In step 612, the controller 324 and the evaluator 326 may enforce the updated configuration and policies. Further, additional run-time telemetry from the current workload may be collected and stored with (for example with a BIOS fingerprints) for future use. In steps 614 and 616 a performance evaluation of the updated BIOS configuration and BIOS telemetry and/or additional recommendations (e.g. beyond specific COREs any uncore aspects that can be tuned if applicable) are exposed to the the BIOS assisted performance middleware 340.

As describe above, in some embodiments the fleet manager 350 may collect and aggregate telemetry data (for example BIOS fingerprints) of a plurality of BIOS assisted performance middlewares across one or more cloud servers in a fleet, that is from a plurality of computing systems and/or from a plurality of virtual machines running on the same or on different computing systems. The collected and aggregated telemetry may be used to train a machine learning algorithm and transfer obtained learning tuning profiles for each of the plurality of BIOS assisted performance middlewares.

FIG. 7a illustrates one virtual machine running on an entire socket 720. A host 710 comprises two sockets 722 and 724. For instance, the host 710 may be a server, for example a public cloud server, for example operated by a cloud service provider. The sockets may be SoC, or processor cores or virtual sockets or the like. The host 710 further comprise a UEFI BIOS, which comprises one UEFI BIOS for both sockets, which comprise a controller 740 as described above. Further, one virtual machine 732 is running on the host, one the first 722 and/or the second socket 724. For example, the single virtual machine 732 is running in one of the dedicated sockets with no peer neighbors on the same socket and the BIOS assisted performance middleware 340 (gAgent) leverages performance tuning (for example of BIOS variables) for the entire socket.

FIG. 7b illustrates multiple virtual machines running each running on its own dedicated socket. FIG. 7b differs from FIG. 7a in that a second virtual machine 734 is running on the second socket 724 and the first virtual machine 732 is running on the first socket 722. Each of the virtual machines comprises a BIOS assisted performance middleware 340a, 340b (gAgent). Because each of the plurality of virtual machines is running a dedicated socket with no peer neighbors on the same socket, the BIOS assisted performance middlewares 340a, 340b (gAgent) leverage performance tuning (for example of BIOS variables) for each of the entire sockets.

FIG. 7c illustrates multiple virtual machines running the same socket. FIG. 7c differs from FIG. 7b in that the first virtual machine 732 and the second virtual machine 734 are both running on the same socket, for example on the first socket 722, that is the multiple virtual machines are sharing resources beyond the CPU. Each of the BIOS assisted performance middlewares 340a, 340b (gAgent) leverage performance tuning for the common socket 722 with regards to their virtual machine (or executed workload) with the proposed technique based on policy configuration, by setting the BIOS variables for the common socket 722 by choosing the lowest common denominator among the shared resources.

In some examples, the based on the virtual machine placement, the proposed BIOS assisted performance middlewares 340 may applied to the (computing) cores of the computing system and/or to other shared resources in the socket/platform, where it is applicable without causing noisiness or side-effect to peer co-existing tenant(s).

In the following, some examples of the proposed concept are presented:

An example (e.g., example 1) relates to an apparatus comprising interface circuitry, machine-readable instructions and processing circuitry to execute the machine-readable instructions to determine one or more configurable firmware variables of a computing system based on performance analysis data of the computing system executing a workload, set the determined one or more configurable firmware variables of the computing system based on reference data, and control the computing system to apply the set firmware variables during run-time.

Another example (e.g., example 2) relates to a previous example (e.g., example 1) or to any other example, further comprising that the processing circuitry is further configured to evaluate a performance of the computing system executing the workload with the applied set one or more firmware variables.

Another example (e.g., example 3) relates to a previous example (e.g., example 2) or to any other example, further comprising that the processing circuitry is further configured to store the data of the performance evaluation of the computing system executing the workload with the applied set one or more firmware variables.

Another example (e.g., example 4) relates to a previous example (e.g., one of the examples 2 or 3) or to any other example, further comprising that the processing circuitry is further configured to apply a machine learning algorithm based on the data of the performance evaluation of the computing system executing the workload with the applied set one or more firmware variables, yielding reference data for the one or more configurable firmware variables.

Another example (e.g., example 5) relates to a previous example (e.g., one of the examples 1 to 4) or to any other example, further comprising that the processing circuitry is further configured to verify if the set firmware variables are within a policy constraint and control the computing system to apply the set one or more firmware variables during run-time if the verification is successful.

Another example (e.g., example 6) relates to a previous example (e.g., one of the examples 1 to 5) or to any other example, further comprising that the processing circuitry is further configured to apply the set one or more firmware variables to the computing system for the executing of one or more further workloads.

Another example (e.g., example 7) relates to a previous example (e.g., one of the examples 1 to 6) or to any other example, further comprising that the processing circuitry is further configured to apply the set one or more firmware variables to the computing system such that they persist after a re-boot of the computing system.

Another example (e.g., example 8) relates to a previous example (e.g., one of the examples 1 to 7) or to any other example, further comprising that the processing circuitry is further configured to set the determined one or more configurable firmware variables based on a trained machine learning model.

Another example (e.g., example 9) relates to a previous example (e.g., one of the examples 1 to 8) or to any other example, further comprising that the processing circuitry is further configured to receive the data of a performance evaluation of one or more second computing systems executing one or more second workloads with one or more second applied set firmware variables, apply a machine learning algorithm based on the data of the performance evaluation of the one or more second computing systems yielding reference data for the one or more configurable firmware variables.

Another example (e.g., example 10) relates to a previous example (e.g., example 9) or to any other example, further comprising that the processing circuitry is further configured to train the machine learning algorithm based on the data of the performance evaluation of one or more second the computing systems.

Another example (e.g., example 11) relates to a previous example (e.g., one of the examples 1 to 10) or to any other example, further comprising that the reference data comprises at least one of application quality of service data for the workload, policy rules for the workload or previous firmware variable settings.

Another example (e.g., example 12) relates to a previous example (e.g., one of the examples 1 to 10) or to any other example, further comprising that the reference data comprises a profile of reference values for the one or more configurable firmware variables.

Another example (e.g., example 13) relates to a previous example (e.g., one of the examples 1 to 12) or to any other example, further comprising that the performance analysis data of the computing system executing a workload comprises at least one of a CPU speed evaluation data, RAM capacity evaluation data, RAM speed evaluation data, storage throughput evaluation data, storage latency evaluation data, network bandwidth evaluation data, network latency evaluation data, GPU performance evaluation data, power consumption evaluation data, thermal metrics evaluation data, and fan speeds evaluation data.

Another example (e.g., example 14) relates to a previous example (e.g., one of the examples 1 to 13) or to any other example, further comprising that the processing circuitry is further configured to run a virtual machine on the computing system, wherein the workload executed by the computing system is a workload of the virtual machine.

Another example (e.g., example 15) relates to a previous example (e.g., example 14) or to any other example, further comprising that the virtual machine is configured to set the determined one or more configurable firmware variables of the computing system based on the reference data and to control the computing system to apply the set firmware variables during run-time.

Another example (e.g., example 16) relates to a previous example (e.g., one of the examples 14 to 15) or to any other example, further comprising that the reference data and/or the set or more firmware variables is/are embedded with a configuration data of the virtual machine.

Another example (e.g., example 17) relates to a previous example (e.g., one of the examples 14 to 16) or to any other example, further comprising that the virtual machine is controlled by a hypervisor, the hypervisor being configured to set the determined one or more configurable firmware variables of the computing system based on the reference data and to control the computing system to apply the set firmware variables during run-time.

Another example (e.g., example 18) relates to a previous example (e.g., one of the examples 1 to 17) or to any other example, further comprising that processing circuitry is further configured to determine one or more configurable system variables of the computing system based on the performance analysis data of the computing system executing a workload, set the determined one or more configurable system variables of the computing system based on reference data, and control the computational system to apply the set one or more system variables during run-time.

Another example (e.g., example 19) relates to a previous example (e.g., one of the examples 1 to 18) or to any other example, further comprising that the firmware is an UEFI BIOS.

Another example (e.g., example 20) relates to a previous example (e.g., one of the examples 1 to 19) or to any other example, further comprising that the one or more configurable firmware variables comprise a runtime or boot-time variable.

Another example (e.g., example 21) relates to a previous example (e.g., one of the examples 1 to 20) or to any other example, further comprising that the one or more configurable firmware variables comprise at least one of a memory optimization variable, I/O optimization variable, CPU optimization variable.

Another example (e.g., example 22) relates to a previous example (e.g., one of the examples 1 to 21) or to any other example, further comprising that the one or more configurable firmware variables comprise one or more authenticated firmware variables.

An example (e.g., example 23) relates to a non-transitory machine-readable storage medium including firmware for an apparatus, the firmware comprising one or more configurable firmware variables, the one or more configurable firmware variables being configured to be changed during run-time of the apparatus based on performance analysis data of the apparatus executing a workload.

An example (e.g., example 24) relates to an apparatus comprising interface circuitry, machine-readable instructions and processing circuitry to execute the machine-readable instructions to determine configurable operating system variables of a computing system based on a performance analysis of the computing system executing a workload, set the determined configurable operating system variables based on reference data, and control the computing system to apply the set operating system variables during run-time.

An example (e.g., example 25) relates to an apparatus comprising processing circuitry configured to determine one or more configurable firmware variables of a computing system based on performance analysis data of the computing system executing a workload, set the determined one or more configurable firmware variables of the computing system based on reference data, and control the computing system to apply the set firmware variables during run-time.

An example (e.g., example 26) relates to a device comprising means for processing for determining one or more configurable firmware variables of a computing system based on performance analysis data of the computing system executing a workload, setting the determined one or more configurable firmware variables of the computing system based on reference data, and controlling the computing system to apply the set firmware variables during run-time.

An example (e.g., example 27) relates to a method comprising determining one or more configurable firmware variables of a computing system based on performance analysis data of the computing system executing a workload, setting the determined one or more configurable firmware variables of the computing system based on reference data, and controlling the computing system to apply the set firmware variables during run-time.

Another example (e.g., example 28) relates to a previous example (e.g., example 27) or to any other example, further comprising evaluating a performance of the computing system executing the workload with the applied set one or more firmware variables.

Another example (e.g., example 29) relates to a previous example (e.g., example 28) or to any other example, further comprising storing the data of the performance evaluation of the computing system executing the workload with the applied set one or more firmware variables.

Another example (e.g., example 30) relates to a previous example (e.g., one of the examples 28 or 29) or to any other example, further comprising applying a machine learning algorithm based on the data of the performance evaluation of the computing system executing the workload with the applied set one or more firmware variables, yielding reference data for the one or more configurable firmware variables.

Another example (e.g., example 31) relates to a previous example (e.g., one of the examples 27 to 30) or to any other example, further comprising verifying if the set firmware variables are within a policy constraint and control the computing system to apply the set one or more firmware variables during run-time if the verification is successful.

Another example (e.g., example 32) relates to a previous example (e.g., one of the examples 27 to 31) or to any other example, further comprising applying the set one or more firmware variables to the computing system for the executing of one or more further workloads.

Another example (e.g., example 33) relates to a previous example (e.g., one of the examples 27 to 32) or to any other example, further comprising applying the set one or more firmware variables to the computing system such that they persist after a re-boot of the computing system.

Another example (e.g., example 34) relates to a previous example (e.g., one of the examples 27 to 33) or to any other example, further comprising setting the determined one or more configurable firmware variables based on a trained machine learning model.

Another example (e.g., example 35) relates to receiving the data of a performance evaluation of one or more second computing systems executing one or more second workloads with one or more second applied set firmware variables, applying a machine learning algorithm based on the data of the performance evaluation of the one or more second computing systems yielding reference data for the one or more configurable firmware variables.

Another example (e.g., example 36) relates to a previous example (e.g., example 35) or to any other example, further comprising training the machine learning algorithm based on the data of the performance evaluation of one or more second the computing systems.

Another example (e.g., example 37) relates to a previous example (e.g., one of the examples 27 to 36) or to any other example, further comprising that the reference data comprises at least one of application quality of service data for the workload, policy rules for the workload or previous firmware variable settings.

Another example (e.g., example 38) relates to a previous example (e.g., one of the examples 27 to 36) or to any other example, further comprising that the reference data comprises a profile of reference values for the one or more configurable firmware variables.

Another example (e.g., example 39) relates to a previous example (e.g., one of the examples 27 to 38) or to any other example, further comprising that the performance analysis data of the computing system executing a workload comprises at least one of a CPU speed evaluation data, RAM capacity evaluation data, RAM speed evaluation data, storage throughput evaluation data, storage latency evaluation data, network bandwidth evaluation data, network latency evaluation data, GPU performance evaluation data, power consumption evaluation data, thermal metrics evaluation data, and fan speeds evaluation data.

Another example (e.g., example 40) relates to a previous example (e.g., one of the examples 27 to 39) or to any other example, further comprising running a virtual machine on the computing system, wherein the workload executed by the computing system is a workload of the virtual machine.

Another example (e.g., example 41) relates to a previous example (e.g., example 40) or to any other example, further comprising that the virtual machine is configured to set the determined one or more configurable firmware variables of the computing system based on the reference data and to control the computing system to apply the set firmware variables during run-time.

Another example (e.g., example 42) relates to a previous example (e.g., one of the examples to 41) or to any other example, further comprising that the reference data and/or the set or more firmware variables is/are embedded with a configuration data of the virtual machine.

Another example (e.g., example 43) relates to a previous example (e.g., one of the examples 40 to 42) or to any other example, further comprising that the virtual machine is controlled by a hypervisor, the hypervisor being configured to set the determined one or more configurable firmware variables of the computing system based on the reference data and to control the computing system to apply the set firmware variables during run-time.

Another example (e.g., example 44) relates to a previous example (e.g., one of the examples 27 to 43) or to any other example, further comprising determining one or more configurable system variables of the computing system based on the performance analysis data of the computing system executing a workload, setting the determined one or more configurable system variables of the computing system based on reference data, and controlling the computational system to apply the set one or more system variables during run-time.

Another example (e.g., example 45) relates to a previous example (e.g., one of the examples 27 to 44) or to any other example, further comprising that the firmware is an UEFI BIOS.

Another example (e.g., example 46) relates to a previous example (e.g., one of the examples 27 to 45) or to any other example, further comprising that the one or more configurable firmware variables comprise a runtime or boot-time variable.

Another example (e.g., example 47) relates to a previous example (e.g., one of the examples 27 to 46) or to any other example, further comprising that the one or more configurable firmware variables comprise at least one of a memory optimization variable, I/O optimization variable, CPU optimization variable.

Another example (e.g., example 48) relates to a previous example (e.g., one of the examples 27 to 47) or to any other example, further comprising that the one or more configurable firmware variables comprise one or more authenticated firmware variables.

Another example (e.g., example 49) relates to a non-transitory machine-readable storage medium including program code, when executed, to cause a machine to perform the method of any one of examples 27 to 48.

Another example (e.g., example 50) relates to a computer program having a program code for performing the method of any one of examples 27 to 48 when the computer program is executed on a computer, a processor, or a programmable hardware component.

Another example (e.g., example 51) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processing circuitry to execute the machine-readable instructions to:
determine one or more configurable firmware variables of a computing system based on performance analysis data of the computing system executing a workload;
set the determined one or more configurable firmware variables of the computing system based on reference data; and
control the computing system to apply the set firmware variables during run-time.

2. The apparatus of claim 1, wherein the processing circuitry is further configured to evaluate a performance of the computing system executing the workload with the applied set one or more firmware variables.

3. The apparatus of claim 2, wherein the processing circuitry is further configured to store the data of the performance evaluation of the computing system executing the workload with the applied set one or more firmware variables.

4. The apparatus of claim 2, wherein the processing circuitry is further configured to apply a machine learning algorithm based on the data of the performance evaluation of the computing system executing the workload with the applied set one or more firmware variables, yielding reference data for the one or more configurable firmware variables.

5. The apparatus of claim 1, wherein the processing circuitry is further configured to verify if the set firmware variables are within a policy constraint and control the computing system to apply the set one or more firmware variables during run-time if the verification is successful.

6. The apparatus of claim 1, wherein the processing circuitry is further configured to apply the set one or more firmware variables to the computing system for the executing of one or more further workloads.

7. The apparatus of claim 1, wherein the processing circuitry is further configured to apply the set one or more firmware variables to the computing system such that they persist after a re-boot of the computing system.

8. The apparatus of claim 1, wherein the processing circuitry is further configured to set the determined one or more configurable firmware variables based on a trained machine learning model.

9. The apparatus of claim 1, wherein the processing circuitry is further configured to:
receive the data of a performance evaluation of one or more second computing systems executing one or more second workloads with one or more second applied set firmware variables;
apply a machine learning algorithm based on the data of the performance evaluation of the one or more second computing systems yielding reference data for the one or more configurable firmware variables.

10. The apparatus of claim 9, wherein the processing circuitry is further configured to train the machine learning algorithm based on the data of the performance evaluation of one or more second the computing systems.

11. The apparatus of claim 1, wherein the reference data comprises at least one of application quality of service data for the workload, policy rules for the workload or previous firmware variable settings.

12. The apparatus of claim 1, wherein the reference data comprises a profile of reference values for the one or more configurable firmware variables.

13. The apparatus of claim 1, wherein the performance analysis data of the computing system executing a workload comprises at least one of a CPU speed evaluation data, RAM capacity evaluation data, RAM speed evaluation data, storage throughput evaluation data, storage latency evaluation data, network bandwidth evaluation data, network latency evaluation data, GPU performance evaluation data, power consumption evaluation data, thermal metrics evaluation data, and fan speeds evaluation data.

14. The apparatus of claim 1, wherein the processing circuitry is further configured to run a virtual machine on the computing system, wherein the workload executed by the computing system is a workload of the virtual machine.

15. The apparatus of claim 14, wherein the virtual machine is configured to set the determined one or more configurable firmware variables of the computing system based on the reference data and to control the computing system to apply the set firmware variables during run-time.

16. The apparatus of claim 14, wherein the reference data and/or the set or more firmware variables is/are embedded with a configuration data of the virtual machine.

17. The apparatus of claim 14, wherein the virtual machine is controlled by a hypervisor, the hypervisor being configured to set the determined one or more configurable firmware variables of the computing system based on the reference data and to control the computing system to apply the set firmware variables during run-time.

18. The apparatus of claim 1, wherein processing circuitry is further configured to:
determine one or more configurable system variables of the computing system based on the performance analysis data of the computing system executing a workload;
set the determined one or more configurable system variables of the computing system based on reference data; and
control the computational system to apply the set one or more system variables during run-time.

19. A non-transitory machine-readable storage medium including firmware for an apparatus, the firmware comprising one or more configurable firmware variables, the one or more configurable firmware variables being configured to be changed during run-time of the apparatus based on performance analysis data of the apparatus executing a workload.

20. A method comprising:
determining one or more configurable firmware variables of a computing system based on performance analysis data of the computing system executing a workload;
setting the determined one or more configurable firmware variables of the computing system based on reference data; and
controlling the computing system to apply the set firmware variables during run-time.
